(19) United States
(12) Patent Application Publication
(10) Pub. No.: US 2025/0074375 A1
(43) Pub. Date: Mar. 6, 2025

(54) BRAKE SYSTEMS WITH MOTOR-DRIVEN MASTER CYLINDERS AND PUMP INLET ATTENTUATORS

(71) Applicant: ZF Active Safety US Inc., Livonia, MI (US)

(72) Inventor: Blaise J. Ganzel, Ann Arbor, MI (US)

(21) Appl. No.: 18/474,714

(22) Filed: Sep. 26, 2023

Related U.S. Application Data
(60) Provisional application No. 63/580,048, filed on Sep. 1, 2023.

(51) Int. Cl. B60T 8/94; B60T 8/175; B60T 13/14; B60T 13/68; B60T 15/02; B60T 17/22

(52) U.S. Cl. CPC B60T 8/94; B60T 8/175; B60T 13/142; B60T 13/148; B60T 13/686; B60T 15/028; B60T 17/22; B60T 2270/203; B60T 2270/402; B60T 2270/404; B60T 2270/82; B60T 2270/88

(57) ABSTRACT

A brake system includes a master cylinder generating pressure at first and second MC outputs for actuating first and second pairs of wheel brakes. A secondary brake module is configured to provide fluid at first and second PTU outputs for actuating the wheel brakes. The secondary brake module includes an electric motor configured to selectively pressurize the hydraulic fluid by transmitting rotary motion to at least two pump pistons. A pump inlet attenuator is interposed hydraulically between a reservoir and the pump pistons and in direct fluid connection with the reservoir via a single return line. An electronic control unit controls at least one of the secondary brake module and the master cylinder responsive to a brake pressure signal. The pump inlet attenuator regulates pressure in the single return line to reduce pressure fluctuations at an inlet side of each pump piston via solely mechanical pressure attenuation.

### RELATED APPLICATION

This application claims priority from U.S. Provisional Patent Application No. 63/580,048 (attorney docket no. 301647-US-PSP), filed 1 Sep. 2023 and titled “Brake Systems with Motor-Driven Master Cylinders and Pump Inlet Attenuators”, the entire contents of which are incorporated herein by reference for all purposes.

This application is related to the technologies disclosed in one or more of U.S. Provisional Patent Application No. 63/580,042 (attorney docket no. 301699-US-PSP), filed 1 Sep. 2023 and titled “Brake Systems with Motor-Driven Master Cylinders and Low Pressure Accumulators”; U.S. patent application Ser. No. 18/474,657 (attorney docket no. 301158-US-NP), filed concurrently herewith and titled “Brake Systems with Motor-Driven Master Cylinders and Bypass Valves”; and U.S. patent application Ser. No. 18/474,678 (attorney docket no. 301699-US-NP), filed concurrently herewith and titled “Brake Systems with Motor-Driven Master Cylinders and Low Pressure Accumulators”; the entire contents of all of which are incorporated herein by reference for all purposes.

### TECHNICAL FIELD

This disclosure relates to an apparatus and method for use of brake systems with motor-driven master cylinders and pump inlet attenuators, and, more particularly, to methods and apparatus of brake systems with motor-driven master cylinders, pump inlet attenuators, and bypass valves.

### BACKGROUND

A brake system may include anti-lock control including a hydraulic braking pressure generator, a braking pressure modulator which is provided in the pressure fluid conduits between the braking pressure generator and the wheel brakes and which serves to vary the braking pressure by changing the volume of a chamber containing the hydraulic fluid, sensors for determining the wheel rotational behavior, and electronic circuits for processing the sensor signals and for generating braking-pressure control signals. Brake systems may also include both anti-lock control and traction slip control, which can use braking pressure modulators for controlled vehicular braking.

Descriptions of prior art brake systems are in U.S. Pat. No. 10,730,501, issued 4 Aug. 2020 to Blaise Ganzel and titled “Vehicle Brake System with Auxiliary Pressure Source”, in U.S. Patent Application Publication No. 2020/0307538, published 1 Oct. 2020 by Blaise Ganzel and titled “Brake System with Multiple Pressure Sources”, and in U.S. Patent Application Publication No. 2023/0048447, published 16 Feb. 2023 by Blaise Ganzel and titled “Apparatus and Method for Control of a Hydraulic Brake System Including Manual Pushthrough”, all of which are incorporated herein by reference in their entirety for all purposes.

### SUMMARY

In an aspect, alone or in combination with any other aspect, a brake system for actuating a plurality of wheel brakes comprising first and second pairs of wheel brakes is described. The system includes a reservoir and a motor-driven master cylinder operable during a normal non-failure braking mode by actuation of an electric motor of the master cylinder to generate brake actuating pressure at first and second MC outputs for hydraulically actuating the first and second pairs of wheel brakes, respectively. A secondary brake module is configured for selectively providing pressurized hydraulic fluid at first and second PTU outputs for actuating the first and second pairs of wheel brakes in at least one of a normal non-failure braking mode and a backup braking mode. The secondary brake module includes an electric PTU motor configured to selectively pressurize the hydraulic fluid by transmitting rotary motion to at least two pump pistons. Each pump piston provides pressurized hydraulic fluid to a corresponding one of the first and second PTU outputs. Each of the first and second PTU outputs provides fluid to a corresponding one of the first and second pairs of wheel brakes. A single return line places the reservoir and each pump piston in hydraulic connection. A pump inlet attenuator is interposed hydraulically between the reservoir and the pump pistons and in direct fluid connection with the reservoir via the single return line. An electronic control unit is provided for controlling at least one of the secondary brake module and the master cylinder responsive to at least one brake pressure signal. The pump inlet attenuator regulates pressure in the single return line to reduce pressure fluctuations at an inlet side of each pump piston via solely mechanical pressure attenuation.

### BRIEF DESCRIPTION OF THE DRAWINGS

For a better understanding, reference may be made to the accompanying drawings, in which:

FIG. 1 is a schematic hydraulic diagram of an example brake system according to an aspect of the present invention;

FIG. 2A is a schematic cross-sectional view of a component of the brake system of FIG. 1, in a first configuration;

FIG. 2B is a schematic cross-sectional view of the component of FIG. 2A, in a second configuration;

FIG. 3 is a schematic cross-sectional view of a component of the brake system of FIG. 1;

FIG. 4 is a cross-section taken along line “4-4” of FIG. 3;

FIG. 5 is a schematic hydraulic diagram of an example brake system according to another aspect of the present invention; and

FIG. 6 is a schematic side view of an example arrangement of components for either of the brake systems of FIGS. 1 and 5.

### DESCRIPTION OF ASPECTS OF THE DISCLOSURE

Unless defined otherwise, all technical and scientific terms used herein have the same meaning as is commonly understood by one of ordinary skill in the art to which the present disclosure pertains.

The invention comprises, consists of, or consists essentially of the following features, in any combination.

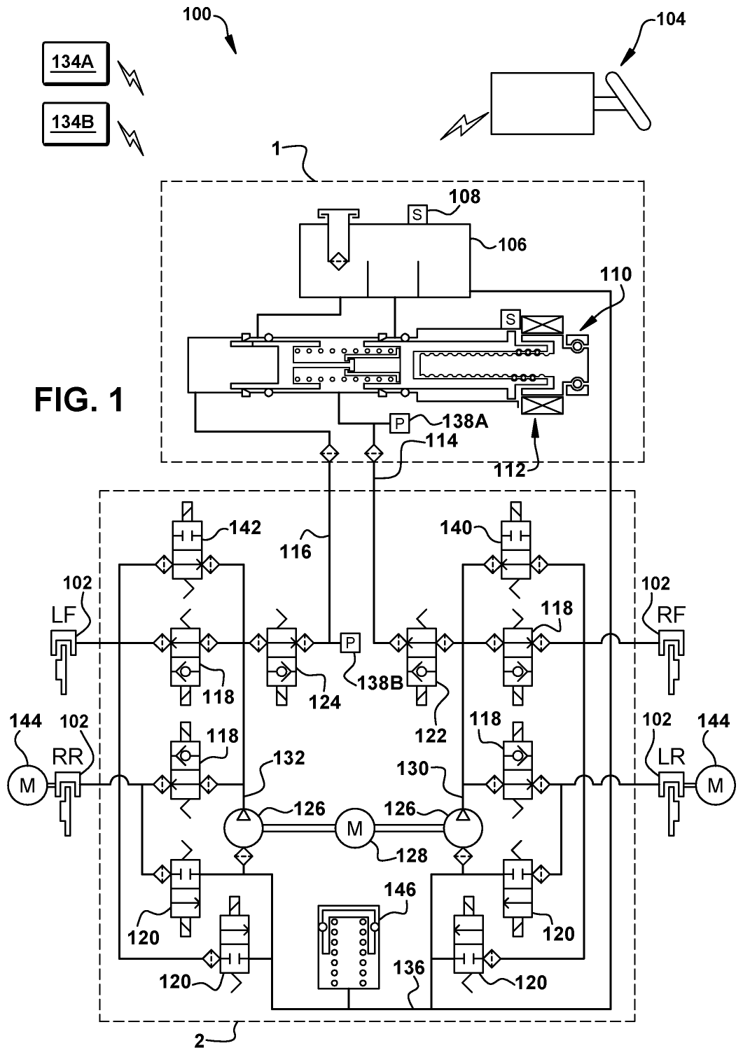

FIG. 1 schematically depicts an example brake system 100 for actuating a plurality of wheel brakes 102. The brake system 100 is shown here as a hydraulic braking system, in which fluid pressure is utilized to apply braking forces for the brake system 100. The brake system 100 may suitably be used on a ground vehicle, such as an automotive vehicle having four wheels with a wheel brake associated with each wheel. Furthermore, the brake system 100 can be provided with other braking functions such as anti-lock braking (ABS) and other slip control features to effectively brake the vehicle. Components of the brake system 100 may be housed in one or more blocks or housings. The blocks or housings may be made from solid material, such as aluminum, that has been drilled, machined, or otherwise formed to house the various components. Fluid conduits may also be formed in the block or housing.

In the illustrated embodiment of the brake system 100 of FIG. 1, there are four wheel brakes 102, which each can have any suitable wheel brake structure operated electrically and/or by the application of pressurized brake fluid. Each of the wheel brakes 102 may include, for example, a brake caliper mounted on the vehicle to engage a frictional element (such as a brake disc) that rotates with a vehicle wheel to effect braking of the associated vehicle wheel. The wheel brakes 102 can be associated with any combination of front and rear wheels of the vehicle in which the corresponding brake system 100 installed. For example, the brake systems 100 may each be configured as a vertically split or diagonally split system. No differentiation is made herein among the construction of the various wheel brakes 102, for the purposes of this description, though one of ordinary skill in the art could readily provide a suitable braking arrangement for a particular use environment. The wheel brakes 102 are described herein as comprising first and second pairs of wheel brakes 102, with the first and second pairs being characterized as RF/LR and LF/RR, as shown as FIG. 1, for the sake of description. However, LF/LR and RF/RR, or RF/LF and RR/LR, pairs could also or instead be specified for the brake system 100, as desired.

Also for the sake of description, it is presumed that a deceleration signal transmitter (shown schematically at 104) is configured to provide a braking signal, in a wired or wireless manner, corresponding to a desired braking action by an operator of the vehicle. The deceleration signal transmitter 104 could include, but not be limited to, a brake pedal, an autonomous braking controller, and/or any other suitable scheme for generating a braking signal from which the brake system 100 can be actuated.

The brake systems 100 also include a fluid reservoir 106. The reservoir 106 stores and holds hydraulic fluid for the brake system 100. The fluid within the reservoir 106 is preferably held at or about atmospheric pressure, but the fluid may be stored at other pressures if desired. The reservoir 106 is shown schematically as having three tanks or sections in FIG. 1, with fluid conduit lines connected thereto. The sections can be separated by several interior walls within the reservoir 106 and are provided to prevent complete drainage of the reservoir 106 in case one of the sections is depleted due to a leakage via one of the three lines connected to the reservoir 106. Alternatively, the reservoir 106 may include multiple separate housings. The reservoir 106 may include at least one fluid level sensor 108 for detecting the fluid level of one or more of the sections of the reservoir 106.

A motor-driven master cylinder (“MC” or “[primary] power transmission unit”) 110 (which may be a dual-chamber type master cylinder 110, also known as a tandem power transmission unit) of each brake system 100 functions as a source of pressure to provide a desired pressure level to the hydraulically operated wheel brakes 102 during a typical or normal non-failure brake apply. An example of a suitable MC 110 arrangement is disclosed in co-pending U.S. patent application Ser. No. 17/708,070, filed 30 Mar. 2022 and titled “Tandem Power Transmission Unit and Brake Systems Using Same” (attorney docket no. 211835-US-NP), which is incorporated by reference herein in its entirety for all purposes. The master cylinder 110 is operable during a normal non-failure braking mode by actuation of an electric motor 112 of the master cylinder 110 to generate brake actuating pressure at first and second MC outputs 114 and 116, respectively, for hydraulically actuating the first and second pairs of wheel brakes 102.

After a brake apply, fluid from the wheel brakes 102 may be returned to the master cylinder 110 and/or be diverted to the reservoir 106. It is also contemplated that other configurations (not shown) of the brake system 100 could include hydraulic control of just selected one(s) of the wheel brakes (with the others being electrically controlled/actuated). One of ordinary skill in the art would be readily able to provide such an arrangement for a desired use environment, following aspects of the present invention.

An iso/dump control valve arrangement is associated with each wheel brake 102 of the plurality of wheel brakes 102. Each iso/dump control valve arrangement includes an iso valve 118 and a dump valve 120, for providing desired fluid routing to an associated wheel brake 102. The reservoir 106 is hydraulically connected to the master cylinder 110 and to each of the iso/dump control valve arrangements, such as via the return line 136. The iso/dump control valve arrangements each include respective serially arranged iso and dump valves 118 and 120. The normally open iso valve 118 for each iso/dump control valve arrangement is located hydraulically between a respective wheel brake 102 and the master cylinder 110, and the normally closed dump valve 120 for each iso/dump control valve arrangement is located hydraulically between a respective wheel brake 102 and the reservoir 106, for the corresponding wheel brake 102.

The iso/dump control valve arrangements may selectively provide slip control to at least one wheel brake 102 powered by the master cylinder 110 and/or the secondary brake module described below. More broadly, the iso/dump control valve arrangement, and/or other valves of the brake system 100, any of which may be solenoid-operated and have any suitable configurations, can be used to help provide controlled braking operations, such as, but not limited to, ABS, traction control, vehicle stability control, dynamic rear proportioning, regenerative braking blending, and autonomous braking.

A first traction control iso valve 122 is hydraulically interposed between the master cylinder 110 and at least one iso/dump control valve arrangement via the first MC output 114. A second traction control iso valve 124 is hydraulically interposed between the master cylinder 110 and at least one iso/dump control valve arrangement via the second MC output 116. As shown in the Figures, it is contemplated that an iso/dump control valve arrangement may be associated with each wheel brake 102 of the first and second pairs of wheel brakes. The first traction control iso valve 122 is hydraulically interposed between the motor-driven master cylinder 110 and the iso/dump control valve arrangements of the first pair of wheel brakes 102. Similarly, the second traction control iso valve 124 is hydraulically interposed between the motor-driven master cylinder 110 and the iso/dump control valve arrangements of the second pair of wheel brakes 102.

A pump piston 126 is associated with at least one wheel brake 102 of the plurality of wheel brakes 102. The pump piston 126 is driven by an electric PTU motor 128 (as differentiated from the electric motor 112 included in the master cylinder 110) which transmits rotary motion to each pump piston 126 for selectively providing pressurized hydraulic fluid to the iso/dump control valve arrangement of at least one wheel brake 102 which is associated with the pump piston 126. FIG. 1 shows one pump piston 126 as being associated with two wheel brakes 102, for a total of two pump pistons 126 in the brake system 100. Together, the pump piston(s) 126 and electric PTU motor 128 can be considered to comprise a secondary brake module (A.K.A. “secondary power transmission unit”) of the brake system 100. For example, the two pump pistons 126 shown in the Figures may provide pressurized hydraulic fluid at first and second PTU outputs 130 and 132, respectively, to the corresponding wheel brakes 102 via the corresponding iso/dump control valve arrangements (when present), to actuate the first and second pairs of wheel brakes 102 in at least one of a normal non-failure braking mode and a backup braking mode. Each of the first and second PTU outputs 130 and 132 can provide fluid to a corresponding one of the first and second pairs of wheel brakes 102. It is contemplated that a plurality of pump pistons 126 could be associated with each of the first and second PTU outputs 130 and 132, in some configurations of the brake system 100.

The secondary brake modules of the brake systems 100 function as a source of pressure to provide a desired pressure level to selected ones of the wheel brakes 102 in a backup or “failed” situation, when, for some reason, the master cylinder 110 is unable to provide fluid to those selected wheel brakes 102. Accordingly, each of the secondary brake modules is directly fluidly connected to the reservoir 106, for exchanging hydraulic fluid between these components without having to route the fluid through a (potentially failed) motor-driven master cylinder 110 or another structure of the brake system 100.

The secondary brake modules can be used to selectively provide hydraulic fluid to at least one of the wheel brakes 102 in a backup braking mode, but also in an enhanced braking mode, which can occur on its own and/or concurrently with either the backup braking mode or a non-failure normal braking mode. Examples of suitable enhanced braking mode functions available to the brake systems 100 include, but are not limited to, “overboost” (in which higher pressure is provided to a particular brake than would normally be available from the master cylinder 110 alone) and “volume-add” (in which more fluid is provided to a particular brake than would normally be available from the master cylinder 110). These enhanced braking modes may be facilitated, in some use environments, by fluid communication from the respective first or second MC output 114 or 116 to a pump input of at least one pump piston 126 for selectively supplying pressurized hydraulic fluid to the pump piston(s) 126. For example, in at least one of the normal non-failure braking mode and the backup braking mode, the secondary brake module can then supply boosted-pressure (above what was obtained from the master cylinder 110) hydraulic fluid to at least one of the first and second PTU outputs 130 or 132.

As can be seen, each iso/dump control valve arrangement in the brake systems 100 shown in the Figures is in direct or indirect fluid communication with both a selected one of the first and second MC outputs 114 and 116 and a selected one of the first and second PTU outputs 130 and 132 for selectively receiving pressurized fluid therefrom, such as during different braking modes or otherwise as desired. One of ordinary skill in the art will be readily able to configure a brake system 100 for any particular use application as desired.

The brake system 100 shown in FIG. 1 also includes at least one electronic control unit (“ECU”) 134, for controlling at least one of the master cylinder 110 and the secondary brake module (via electric PTU motor 128) responsive to at least one brake pressure signal, with first and second ECUs 134A, 134B being shown and described herein. The ECUs 134A, 134B may include microprocessors and other electrical circuitry. The ECUs 134A, 134B receive various signals, process signals, and control the operation of various electrical components of a corresponding brake system 100 in response to the received signals, in a wired and/or wireless manner. The ECUs 134A, 134B can be connected to various sensors such as the reservoir fluid level sensor(s) 108, pressure sensors, travel sensors, switches, wheel speed sensors, and steering angle sensors. The ECUs 134A, 134B may also be connected to an external module (not shown) for receiving information related to yaw rate, lateral acceleration, longitudinal acceleration of the vehicle, or other characteristics of vehicle operation for any reason, such as, but not limited to, controlling the brake system 100 during vehicle braking, stability operation, or other modes of operation. Additionally, the ECUs 134A, 134B may be connected to the instrument cluster for collecting and supplying information related to warning indicators such as an ABS warning light, a brake fluid level warning light, and a traction control/vehicle stability control indicator light. It is contemplated that at least one of the ECUs 134A and 134B may be, for example, integrated with the master cylinder 110 or the electric PTU motor 128.

The first and second ECUs 134A and 134B may divide the control tasks for the brake system 100 in any desired manner, and may be readily configured by one of ordinary skill in the art for a particular use environment of a brake system, though it is contemplated that any control tasks performed by one or more ECUs 134 will be accomplished responsive to at least one brake pressure signal and/or a braking signal produced by the deceleration signal transmitter 104. For example, the first ECU 134A may be operative to control the electric motor 136 of the master cylinder 110. The second ECU 150 4B may be operative to control the electric PTU motor 128, at least one of the iso/dump control valve arrangements, and at least one of the first and second traction control iso valves 122, 124.

A “brake pressure signal” is referenced above as being at least one input that an ECU 134 may consider and responsively control one or more other components of the brake system 100, to achieve desired braking results for a particular use environment. One potential source of the brake pressure signal is a brake pressure sensor. For example, and as shown in the Figures, the brake system 100 can include at least one, such as at least two, brake pressure sensors 138. As can be seen in FIG. 1, a first brake pressure sensor 138A may be interposed hydraulically between the first traction control iso valve 122 and the master cylinder 110, and a second brake pressure sensor 138B may be interposed hydraulically between the second traction control iso valve 124 and a the master cylinder 110. One of ordinary skill in the art can readily provide a desired number/position/type of pressure sensors 138 for a particular brake system 100.

A first bypass iso valve 140 is hydraulically interposed between the first traction control iso valve 122 and a front brake of the first pair of wheel brakes 102, in parallel with the iso/dump control valve arrangement corresponding to the front brake of the first pair of wheel brakes 102. A second bypass iso valve 142 is hydraulically interposed between the second traction control iso valve 124 and a front brake of the second pair of wheel brakes 102, in parallel with the iso/dump control valve arrangement corresponding to the front brake of the second pair of wheel brakes 102. The first and second bypass iso valves 140 and 142 shown in FIG. 1 are shown as being normally open iso valves.

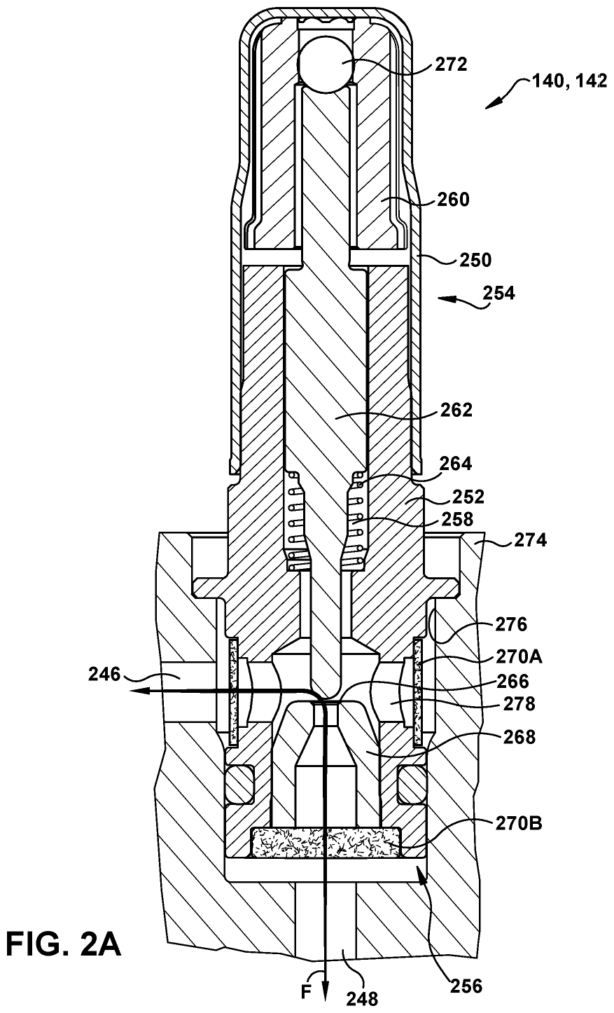

The first and second bypass iso valves 140 and 142 are configured to close responsive to higher hydraulic fluid pressure on an upstream (i.e., closer to the master cylinder 110) side of the respective bypass iso valves 140 and 142, to facilitate the brake system 100 holding the first and second bypass iso valves 140 and 142 closed with relatively low current draw on the system. The first and second bypass iso valves 140 and 142 also have a larger orifice size than an orifice size of the iso valve 118 of the corresponding iso/dump control valve arrangement, and are oriented in an opposite fluid flow direction as is the iso valve 118 of the corresponding iso/dump control valve arrangement (i.e., plumbed in a “reverse” direction to the corresponding iso valves 118). As a result, the first and second bypass iso valves 140 and 142 can thus help pressurize the wheel brakes 102 quickly during a “spike apply” situation. (It should be noted that the first and second bypass iso valves 140 and 142 may also have a larger orifice size than an orifice size of the corresponding first and second traction control iso valves 122 and 124, as well.) An example of usage of the first and second bypass iso valves 140 and 142 is that an undesirably large pressure spike can occur once an iso valve 118 closes, since the electric motor 112 of the master cylinder 110 has inertia and takes a predetermined amount of time to stop spinning and driving the piston in the chamber of the master cylinder 110. Presence of the first and second bypass iso valves 140 and 142 in handling a “spike apply” situation also allows the use of a smaller corresponding iso valve 118 because the electric motor 112 won't need to rotate as quickly to achieve a desired amount of fluid pressure at the associated wheel brake 102. The structure of the first and second bypass iso valves 140 and 142 will be discussed in more detail below with reference to FIGS. 2A-2B.

An electric brake motor 144 may be associated with each of the rear wheel brakes of the front and rear pairs of wheel brakes 102. When present, the electric brake motors 144 may be operative in at least the backup braking mode and may be controlled by an opposite ECU 134 (responsive to the braking signal) as is the electric motor 112 of the master cylinder 110, when multiple ECUs 134 are present. For example, when the first ECU 134A controls the electric motor 112 of the master cylinder 110, the second ECU 134B may control the electric PTU motor 128 and the electric brake motors 144, for redundancy in the brake system 100 if the first ECU 134A should fail.

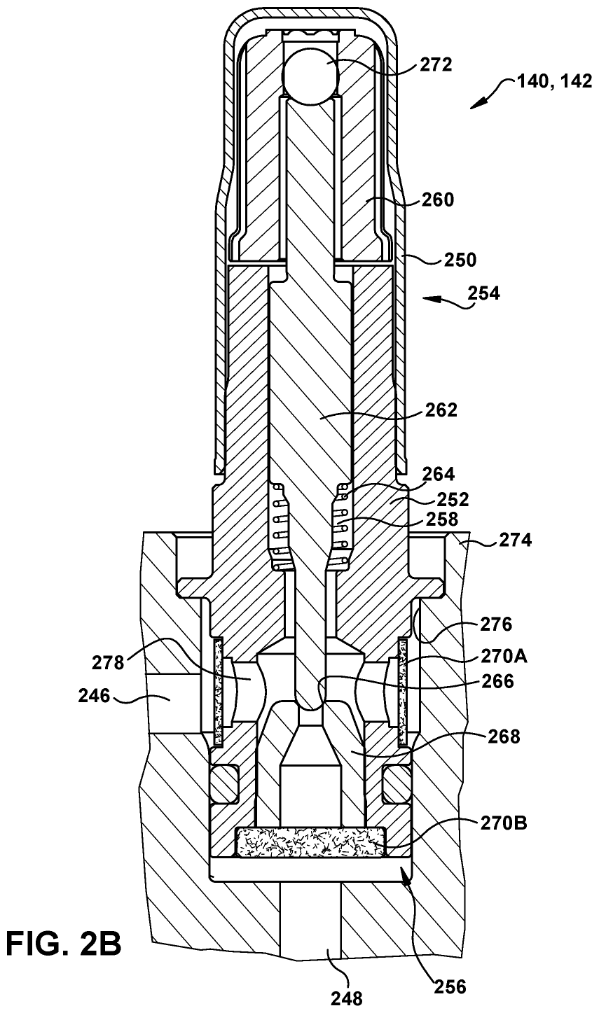

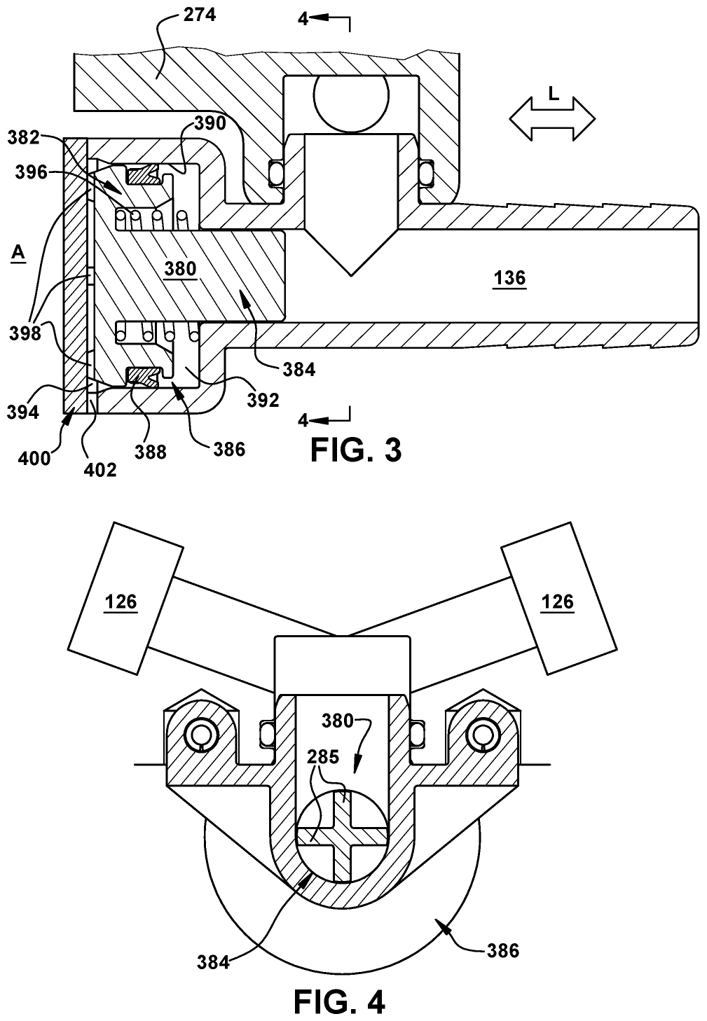

In the brake system 100 of FIG. 1, a single return line 136 places the reservoir 106 and each pump piston 126 in hydraulic connection. The brake system 100 also includes a pump inlet attenuator 146 interposed hydraulically between the reservoir 106 and the pump pistons 126 for “damping” fluid flow therebetween. The pump inlet attenuator 146 is in direct fluid connection with the reservoir 106 via the single return line 136 and regulates pressure in the single return line 136 to reduce pressure fluctuations at an inlet side of each pump piston 126 via solely mechanical pressure attenuation. At least a portion of the pump inlet attenuator 146 may be in fluid communication with an ambient space outside the brake system 100, as will be discussed below with reference to FIGS. 3-4. The pump inlet attenuator 146 may be a single pump inlet attenuator 146 as shown and discussed herein, or it is contemplated that multiple pump inlet attenuators (not shown) may be provided for certain use environments of the brake system 100.

Known brake systems require the column of fluid in the return line 136 to accelerate and decelerate due to the flow ripple generated at the inlets of the pump pistons 126. This causes undesirable pressure ripple and decreased pump volumetric efficiency. Conversely, presence of the pump inlet attenuator 146 facilitates improved pump build rate performance with a smaller-diameter and/or longer return line 136. The pump inlet attenuator 146 (A.K.A., “pump inlet damper”) can be packaged inline in the return line 136 (e.g., in a reservoir hose adapter of the brake system 100) or “piggybacked” in a housing body structure of another component (e.g., a secondary brake module). Since the pump pistons 126 of the brake system 100 pull relatively low-pressure fluid from the return line 136 (within which the pump inlet attenuator 146 is inline), the pump inlet attenuator 146 does not need to be able to withstand the relatively high pressures developed in conduits sourced from the master cylinder 110. Thus, the pump inlet attenuator 146 can service both/all of the pump pistons 126 concurrently, but still with relatively inexpensive (e.g., molded plastic) components since the pump inlet attenuator 146 is operating in a low-pressure environment, as shown.

FIGS. 2A-2B will be described below as pertaining to the first bypass iso valve 140 for simplicity, but the second bypass iso valve 142 will be structured similarly, in many use environments. FIG. 2A depicts the bypass valve 140, 142 in an open condition, and the bypass valve 140, 142 is energized closed in FIG. 2B. With reference to FIGS. 2A-2B, the first and second bypass iso valves 140 and 142 may each include an MC passage 246 in fluid communication with a corresponding first or second MC output 114, 116, a brake-side passage 248 in fluid communication with a corresponding front wheel brake 102, and a longitudinally extending bypass valve sleeve 250. The MC passage 246 may be in indirect fluid communication with the corresponding first or second MC output 114, 116 via a corresponding first or second traction control iso valve 122, 124. The brake-side passage 248 may be in direct fluid communication with the corresponding front wheel brake 102. One of ordinary skill in the art can readily configure a brake system 100 including one or more bypass iso valves 140 and 142, for a particular use environment.

A bypass valve body 252 has longitudinally spaced first and second body ends 254 and 256, respectively, with a bypass body lumen 258 extending therebetween. The bypass valve body 252 spaces at least a portion of the bypass valve sleeve 250 (which at least partially surrounds the first body end 254) away from at least the brake-side passage 248, which is located adjacent the second body end 256. A bypass armature 260 is located within the bypass valve sleeve 250 adjacent the first body end 256. A bypass tappet 262 is at least partially surrounded by the bypass armature 260 and the bypass valve sleeve 250. The bypass tappet 262 extends at least partially through the bypass body lumen 258. The bypass tappet 262 is selectively moved longitudinally within the bypass body lumen 258 toward the bypass valve body 252 via energization of the bypass armature 260. A bypass biasing spring 264 is mechanically interposed between the bypass tappet 262 and at least a portion of the bypass valve body 252 within the bypass body lumen 258. The bypass biasing spring 264 is operative to bias the bypass tappet 262 toward the first body end 254. A bypass valve seat 266 is carried by a bypass seat body 268 located directly adjacent the second body end 256.

Any desired number of bypass valve filters 270 can be provided and are shown here as a band filter 270A and a disc filter 270B, associated with the MC passage 246 and the brake-side passage 248, respectively. An air gap spacer 272 may be provided to assist with keeping tolerances and/or transferring forces between components as desired. The bypass valve 140, 142 may be carried by a housing block 274 of a brake system 100, and at least a portion of the MC passage 246 and the brake-side passage 248 may be formed within the housing block 274. The bypass valve body 252, or any other desired components of the bypass valve 140, 142 may be maintained within a valve bore 276 of the housing block 274 through staking, crimping, welding, soldering, adhesive, fasteners, or any other desired maintenance scheme.

A bypass valve fluid path F extends (in a bidirectional manner) through a selected one of the MC passage 246 and the brake-side passage 248, past the bypass valve seat 266, through at least one laterally extending side aperture 278 in the bypass valve body 252, through at least a portion of the bypass body lumen 258, and through the other one of the MC passage 246 and the brake-side passage 248 to place these two passages in fluid communication. This is the “normally open” position shown in FIG. 2A.

In the “energized closed” position shown in FIG. 2B, the bypass tappet 262 selectively engages with the bypass valve seat 266 to substantially occlude the bypass valve fluid path F responsive to energization of the bypass armature 260 moving the bypass tappet 262 toward the second body end 256.

The pump inlet attenuator 146 is shown in FIGS. 3-4. A PIA piston 380 has a piston head 382 and a piston stem 384. The piston stem 384 has at least one rib 385 extending longitudinally therealong—as shown, a plurality of ribs 385 cooperatively define a piston stem 384 having an at least partially cruciform cross-section, to facilitate brake fluid flow within the pump inlet attenuator 146. The PIA piston 380 is hydraulically interposed between the pump pistons 126 and an ambient space “A” outside the brake system 100.

A PIA piston chamber 386 circumferentially surrounds the piston head 382, and the piston head 382 reciprocates longitudinally (i.e., parallel to arrow “L” of FIG. 3) within the PIA piston chamber 386. A PIA seal 388 is interposed laterally between the piston head 382 and an inner wall 390 of the PIA piston chamber 386 to divide the PIA piston chamber 386 into longitudinally spaced wet and dry chamber sections 392 and 394, respectively. The dry chamber section 394 is the portion of the pump inlet attenuator 146 which is in fluid communication with the ambient space A outside the brake system 100. A PIA spring 396 biases the PIA piston 380 toward the dry chamber section 394. At least one holdoff 398 may be located on an outermost portion of the piston head 380 to prevent a face of the piston head 380 from coming completely into contact with the solid retainer disc 402. Air can be exchanged between the ambient space A and the dry chamber section 384 via vent line 402. Conversely, it is contemplated that the retainer disc 402 could include one or more perforations, throughholes, or be at least partially made of an air-permeable material (nor shown) to allow exchange of air with the ambient space A directly therethrough, without the vent line 402.

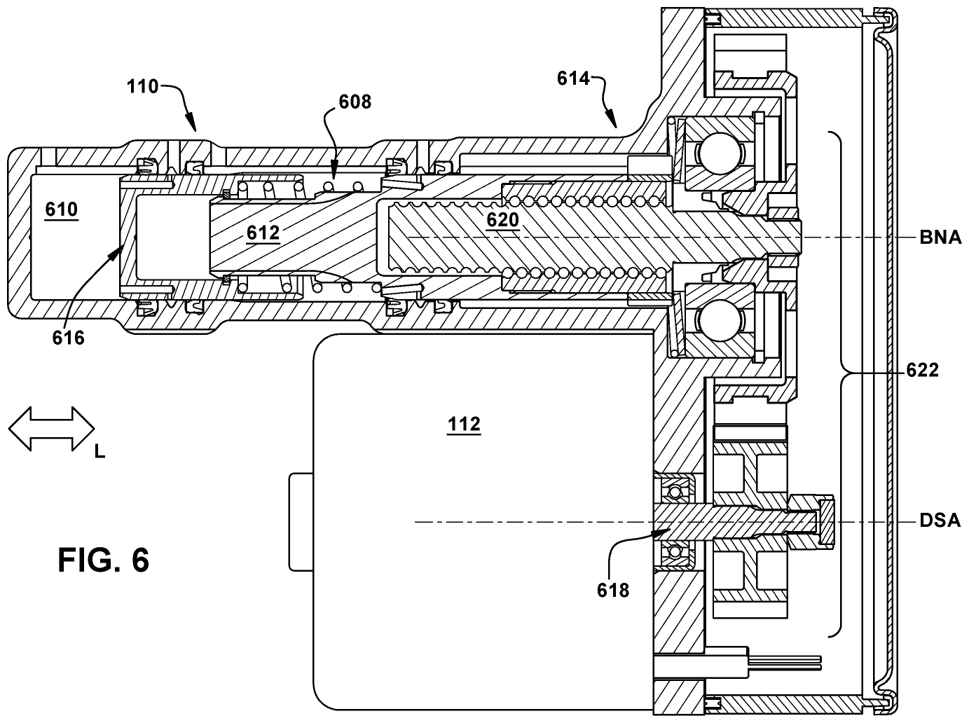

The PIA piston 380 moves longitudinally toward the pump pistons (shown schematically at 126 in FIG. 6) responsive to application of a first predetermined amount of negative pressure from the pump pistons 126. The PIA piston 380 moves longitudinally away from the pump pistons 126 (i.e., toward the retainer disc 402) responsive to one or more of a biasing force from the PIA spring 396, a second predetermined amount of negative pressure (the second predetermined amount of negative pressure being smaller than the first predetermined amount of negative pressure) from the pump pistons 126, and a predetermined amount of positive pressure from the pump pistons 126. As shown in FIG. 3, the depicted pump inlet attenuator 146 has a “stub” type connector with a seal around it, and it inserted into the housing block 274 and thus into fluid communication with the pump pistons 136, but it is contemplated that any suitable placement and attachment scheme could be provided to connect the pump inlet attenuator 146 into the brake system 100, as desired. More generally, one of ordinary skill in the art can readily provide a suitable pump inlet attenuator 146 for a particular use application of the brake system 100.

With reference now to FIG. 1, the reservoir 106 and motor-driven master cylinder 110 may be co-located in a first housing (indicated schematically by dashed line “1” in those Figures), and the secondary brake module may be located in a second housing (indicated schematically by dashed line “2” in those Figures), spaced apart from the first housing. Optionally, and also as shown in FIG. 1, the iso/dump control valve arrangements, the first and second bypass iso valves 140 and 142 and/or the first and second traction control iso valves 122 and 124 may also be located in the second housing.

The first and second housings (and included/co-located components) of any brake systems 100 may be provided and configured for a particular use application by one of ordinary skill in the art based upon factors including, but not limited to, achieving desired outcomes in at least one of design, manufacturing, service, spatial utilization in the vehicle, cost, size, regulatory compliance, or the like.

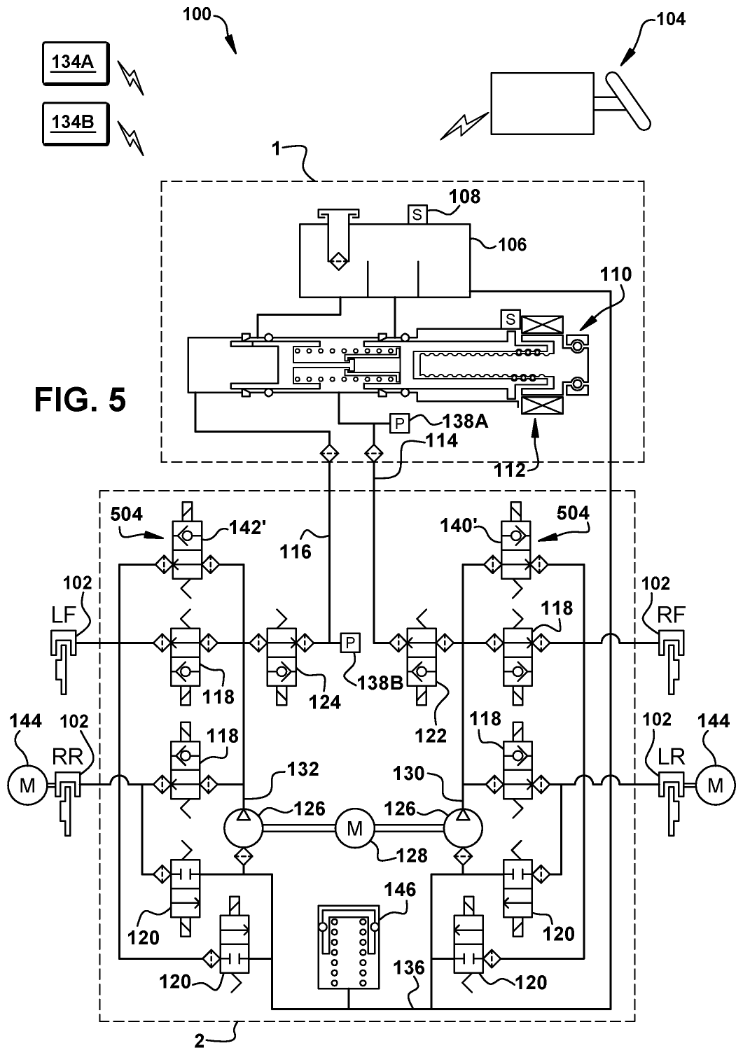

FIG. 5 illustrates a second embodiment of a brake system 100. The brake system of FIG. 5 is similar to the brake system of FIG. 1, and therefore, structures of FIG. 5 that are the same as or similar to those described with reference to FIG. 1 have the same reference numbers. Description of common elements and operation similar to those in the previously described first embodiment will not be repeated with respect to the second embodiment, but should instead be considered to be incorporated below by reference as appropriate.

In the brake system 100 of FIG. 5, each of the first and second bypass iso valves 140′ and 142′ is a same iso valve type as is the iso valve 118 of the corresponding iso/dump control valve arrangement (rather than being the FIG. 2A-2B bypass iso valve 140, 142 of the first embodiment of the brake system 100 shown in FIG. 1). That is, in the second embodiment of the brake system 100 shown in FIG. 5, each of the first and second bypass iso valves 140′ and 142′ includes a check valve mechanism 504 selectively permitting fluid flow therethrough. Each of the first and second bypass iso valves 140′ and 142′ is configured to open responsive to higher hydraulic fluid pressure on an upstream (i.e., closer to the master cylinder 110) side of the bypass valve 140′ and 142″—again, in contrast with the FIG. 1 arrangement. In the brake system 100 of FIG. 5, the orifices of the first and second bypass iso valves 140′ and 142′ are larger than the corresponding orifices of the first and second bypass iso valves 140 and 142 discussed above, at least partially because the first and second bypass iso valves 140′ and 142′ ae not used to do pressure control in the FIG. 4 brake system 100, but instead just remain closed during slip control events. The brake system 100 shown in FIG. 5 may be simpler to construct than that of FIG. 1, because the FIG. 5 brake system includes one fewer type of valve to be provided and configured.

FIG. 6 schematically depicts a physical arrangement of at least a portion of a brake system 100, which could be embodied, for example, as at least a portion of a first housing “1” of either the first or second embodiments of the brake systems 100 shown in FIGS. 1 and 5. In either of these brake systems 100, the motor-driven master cylinder 110 includes an electric MC drive motor 112 (as previously mentioned), a primary MC chamber 608, and a secondary MC chamber 610. A primary MC piston 612 is configured for selective movement longitudinally within the primary MC chamber 608 responsive to longitudinal motion imparted by a ball nut assembly 614 along a ball nut axis “BNA”. (The “longitudinal” direction is indicated by arrow “L” in FIG. 6.) A secondary MC piston 616 is configured for selective movement longitudinally within at least one of the primary and secondary MC chambers 608 and 610 responsive to longitudinal motion imparted by the ball nut assembly 614 along the ball nut axis BNA.

The MC drive motor 112 rotates a drive shaft 618 having a drive shaft axis (“DSA”) which extends substantially parallel to the ball nut axis BNA. Rotational motion of the drive shaft 618 is transferred to rotational motion of a spindle 620 of the ball nut assembly 614 via an MC gear train 622. To emphasize, in the physical arrangement depicted in FIG. 6, rotational motion is imparted by the electric MC drive motor 112 to the drive shaft 618, and then the MC gear train 622 shifts that rotational motion to a laterally spaced and substantially parallel spindle 620 in order to rotate the ball nut assembly 614 and responsively drive the master cylinder 110. This “U-turn” of the motive force from the electric MC drive motor 112 facilitates the provision of a compact package size and reduced footprint for the included components within the brake system 100 physical configuration.

It is contemplated that various other components, such as electric service and/or parking brake motors, could be provided by one of ordinary skill in the art to achieve desired configurations for particular use environments, in any of the brake systems described herein. For example, while a number of filters and pressure or other sensors are shown in the Figures, specific description thereof has been omitted herefrom for brevity, as one of ordinary skill in the art will readily understand how to provide a desired number, placement, and/or operation of filters, sensors, and any other components as desired for a particular use environment of the present invention.

As used herein, the singular forms “a”, “an”, and “the” can include the plural forms as well, unless the context clearly indicates otherwise. It will be further understood that the terms “comprises” and/or “comprising”, as used herein, can specify the presence of stated features, steps, operations, elements, and/or components, but do not preclude the presence or addition of one or more other features, steps, operations, elements, components, and/or groups thereof.

As used herein, the term “and/or” can include any and all combinations of one or more of the associated listed items.

It will be understood that when an element is referred to as being “on”, “attached” to, “connected” to, “coupled” with, “contacting”, “adjacent”, etc., another element, it can be directly on, attached to, connected to, coupled with, contacting, or adjacent the other element, or intervening elements may also be present. In contrast, when an element is referred to as being, for example, “directly on”, “directly attached” to, “directly connected” to, “directly coupled” with, “directly contacting”, or “directly adjacent” another element, there are no intervening elements present. It will also be appreciated by those of ordinary skill in the art that references to a structure or feature that is disposed “directly adjacent” another feature may have portions that overlap or underlie the adjacent feature, whereas a structure or feature that is disposed “adjacent” another feature might not have portions that overlap or underlie the adjacent feature.

Spatially relative terms, such as “under”, “below”, “lower”, “over”, “upper”, “proximal”, “distal”, and the like, may be used herein for ease of description to describe one element or feature's relationship to another element(s) or feature(s) as illustrated in the figures. It will be understood that the spatially relative terms can encompass different orientations of a device in use or operation, in addition to the orientation depicted in the figures. For example, if a device in the figures is inverted, elements described as “under” or “beneath” other elements or features would then be oriented “over” the other elements or features.

As used herein, the phrase “at least one of X and Y” can be interpreted to include X, Y, or a combination of X and Y. For example, if an element is described as having at least one of X and Y, the element may, at a particular time, include X, Y, or a combination of X and Y, the selection of which could vary from time to time. In contrast, the phrase “at least one of X” can be interpreted to include one or more Xs.

It will be understood that, although the terms “first”, “second”, etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or steps) is not limited to the order presented in the claims or figures unless specifically indicated otherwise.

While aspects of this disclosure have been particularly shown and described with reference to the example aspects above, it will be understood by those of ordinary skill in the art that various additional aspects may be contemplated. For example, the specific methods described above for using the apparatus are merely illustrative; one of ordinary skill in the art could readily determine any number of tools, sequences of steps, or other means/options for placing the above-described apparatus, or components thereof, into positions substantively similar to those shown and described herein. In an effort to maintain clarity in the Figures, certain ones of duplicative components shown have not been specifically numbered, but one of ordinary skill in the art will realize, based upon the components that were numbered, the element numbers which should be associated with the unnumbered components; no differentiation between similar components is intended or implied solely by the presence or absence of an element number in the Figures. Any of the described structures and components could be integrally formed as a single unitary or monolithic piece or made up of separate sub-components, with either of these formations involving any suitable stock or bespoke components and/or any suitable material or combinations of materials. Any of the described structures and components could be disposable or reusable as desired for a particular use environment. Any component could be provided with a user-perceptible marking to indicate a material, configuration, at least one dimension, or the like pertaining to that component, the user-perceptible marking potentially aiding a user in selecting one component from an array of similar components for a particular use environment. A “predetermined” status may be determined at any time before the structures being manipulated actually reach that status, the “predetermination” being made as late as immediately before the structure achieves the predetermined status. The term “substantially” is used herein to indicate a quality that is largely, but not necessarily wholly, that which is specified—a “substantial” quality admits of the potential for some relatively minor inclusion of a non-quality item. Though certain components described herein are shown as having specific geometric shapes, all structures of this disclosure may have any suitable shapes, sizes, configurations, relative relationships, cross-sectional areas, or any other physical characteristics as desirable for a particular application. Any structures or features described with reference to one aspect or configuration could be provided, singly or in combination with other structures or features, to any other aspect or configuration, as it would be impractical to describe each of the aspects and configurations discussed herein as having all of the options discussed with respect to all of the other aspects and configurations. A device or method incorporating any of these features should be understood to fall under the scope of this disclosure as determined based upon the claims below and any equivalents thereof.

Other aspects, objects, and advantages can be obtained from a study of the drawings, the disclosure, and the appended claims.

I claim:

1. A brake system for actuating a plurality of wheel brakes comprising first and second pairs of wheel brakes, the system comprising:
a reservoir;
a motor-driven master cylinder operable during a normal non-failure braking mode by actuation of an electric motor of the master cylinder to generate brake actuating pressure at first and second MC outputs for hydraulically actuating the first and second pairs of wheel brakes, respectively;
a secondary brake module configured for selectively providing pressurized hydraulic fluid at first and second PTU outputs for actuating the first and second pairs of wheel brakes in at least one of a normal non-failure braking mode and a backup braking mode, the secondary brake module including an electric PTU motor configured to selectively pressurize the hydraulic fluid by transmitting rotary motion to at least two pump pistons, each pump piston providing pressurized hydraulic fluid to a corresponding one of the first and second PTU outputs, each of the first and second PTU outputs providing fluid to a corresponding one of the first and second pairs of wheel brakes;
a single return line placing the reservoir and each pump piston in hydraulic connection;
a pump inlet attenuator interposed hydraulically between the reservoir and the pump pistons and in direct fluid connection with the reservoir via the single return line; and
an electronic control unit for controlling at least one of the secondary brake module and the master cylinder responsive to at least one brake pressure signal;
wherein the pump inlet attenuator regulates pressure in the single return line to reduce pressure fluctuations at an inlet side of each pump piston via solely mechanical pressure attenuation.

2. The brake system of claim 1, including an iso/dump control valve arrangement associated with each wheel brake of the plurality of wheel brakes, each iso/dump control valve arrangement being controlled by the electronic control unit.

3. The brake system of claim 2, wherein each iso/dump control valve arrangement is in fluid communication with both a selected one of the first and second MC outputs and a selected one of the first and second PTU outputs for selectively receiving pressurized hydraulic fluid therefrom.

4. The brake system of claim 1, wherein the secondary brake module includes a plurality of pump pistons associated with each of the first and second PTU outputs.

5. The brake system of claim 1, including
a first traction control iso valve hydraulically interposed between the motor-driven master cylinder and the first pair of wheel brakes via the first MC outlet; and
a second traction control iso valve hydraulically interposed between the motor-driven master cylinder and the second pair of wheel brakes via the second MC outlet.

6. The brake system of claim 5, wherein a first brake pressure sensor is interposed hydraulically between the first MC output and a corresponding first traction control iso valve and a second brake pressure sensor is interposed hydraulically between the second MC output and a corresponding second traction control iso valve.

7. The brake system of claim 5, including an iso/dump control valve arrangement associated with each wheel brake of the first and second pairs of wheel brakes, wherein the first traction control iso valve is hydraulically interposed between the motor-driven master cylinder and the iso/dump control valve arrangements of the first pair of wheel brakes, and wherein the second traction control iso valve is hydraulically interposed between the motor-driven master cylinder and the iso/dump control valve arrangements of the second pair of wheel brakes.

8. The brake system of claim 7, including a first bypass iso valve hydraulically interposed between the first traction control iso valve and a front brake of the first pair of wheel brakes, and including a second bypass iso valve hydraulically interposed between the second traction control iso valve and a front brake of the second pair of wheel brakes, wherein each of the first and second bypass iso valves has a larger orifice size than an orifice size of the iso valve 118 of the corresponding iso/dump control valve arrangement.

9. The brake system of claim 8, wherein each of the first and second bypass iso valves is a normally open iso valve and is configured to close responsive to higher hydraulic fluid pressure on an upstream (i.e., closer to the master cylinder) side of the bypass valve.

10. The brake system of claim 8, wherein each of the first and second bypass iso valves is configured to open responsive to higher hydraulic fluid pressure on an upstream (i.e., closer to the master cylinder) side of the bypass valve.

11. The brake system of claim 10, wherein each of the first and second bypass iso valves includes a check valve mechanism selectively permitting fluid flow therethrough.

12. The brake system of claim 7, including a first bypass iso valve hydraulically interposed between the first traction control iso valve and a front brake of the first pair of wheel brakes, and including a second bypass iso valve hydraulically interposed between the second traction control iso valve and a front brake of the second pair of wheel brakes, wherein each of the first and second bypass iso valves is a same iso valve type as is the iso valve of the iso/dump control valve arrangement.

13. The brake system of claim 7, including a first bypass iso valve hydraulically interposed between the first traction control iso valve and a front brake of the first pair of wheel brakes, and including a second bypass iso valve hydraulically interposed between the second traction control iso valve and a front brake of the second pair of wheel brakes, wherein each of the first and second bypass iso valves is oriented in an opposite fluid flow direction as is the iso valve of the iso/dump control valve arrangement.

14. The brake system of claim 1, wherein at least a portion of the pump inlet attenuator is in fluid communication with an ambient space outside the brake system.

15. The brake system of claim 7, wherein the first and second bypass iso valves each include:
an MC passage in fluid communication with a corresponding first or second MC outlet;
a brake-side passage in fluid communication with a corresponding front wheel brake;
a longitudinally extending bypass valve sleeve;
a bypass valve body having longitudinally spaced first and second body ends with a bypass body lumen extending therebetween, the bypass valve body spacing at least a portion of the bypass valve sleeve, at least partially surrounding the first body end, away from at least the brake-side passage, located adjacent the second body end;
a bypass armature located within the bypass valve sleeve adjacent the first body end;
a bypass tappet at least partially surrounded by the bypass armature and the bypass valve sleeve, the bypass tappet extending at least partially through the bypass body lumen, the bypass tappet being selectively moved longitudinally within the bypass body lumen toward the bypass valve body via energization of the bypass armature; and
a bypass valve seat carried by a bypass seat body located directly adjacent the second body end;
wherein a bypass valve fluid path extends through a selected one of the MC passage and the brake-side passage, past the bypass valve seat, through at least one laterally extending side aperture in the bypass valve body through at least a portion of the bypass body lumen, and through the other one of the MC passage and the brake-side passage; and
wherein the bypass tappet selectively engages with the bypass valve seat to substantially occlude the bypass valve fluid path responsive to energization of the bypass armature moving the bypass tappet toward the second body end.

16. The brake system of claim 15, wherein the MC passage is in indirect fluid communication with the corresponding first or second MC outlet via a corresponding first or second traction control iso valve and the brake-side passage is in direct fluid communication with the corresponding front wheel brake.

17. The brake system of claim 15, including a bypass biasing spring mechanically interposed between the bypass tappet and at least a portion of the bypass valve body within the bypass body lumen, the bypass biasing spring being operative to bias the tappet toward the first body end.

18. The brake system of claim 1, wherein the pump inlet attenuator includes:
a PIA piston having a piston head and a piston stem, the piston stem having at least one rib extending longitudinally therealong, the PIA piston being hydraulically interposed between the pump pistons and an ambient space outside the brake system,
a PIA piston chamber circumferentially surrounding the piston head;
a PIA seal interposed laterally between the piston head and an inner wall of the PIA piston chamber, the PIA seal dividing the PIA piston chamber into longitudinally spaced wet and dry chamber sections, the dry chamber section being in fluid communication with the ambient space outside the brake system; and
a PIA spring biasing the PIA piston toward the dry chamber section;
wherein the PIA piston moves longitudinally toward the pump pistons responsive to application of a first predetermined amount of negative pressure from the pump pistons, and the PIA piston moves longitudinally away from the pump pistons responsive to at least one of a biasing force from the PIA spring, a second predetermined amount of negative pressure, the second predetermined amount of negative pressure being smaller than the first predetermined amount of negative pressure, from the pump pistons, and a predetermined amount of positive pressure from the pump pistons.

19. The brake system of claim 1, wherein the pump inlet attenuator is a single pump inlet attenuator.

20. The brake system of claim 1, wherein the motor-driven master cylinder includes an electric MC drive motor, a primary MC chamber, a secondary MC chamber, a primary MC piston configured for selective movement longitudinally within the primary MC chamber responsive to longitudinal motion imparted by a ball nut assembly along a ball nut axis, and a secondary MC piston configured for selective movement longitudinally within at least one of the primary and secondary MC chambers responsive to longitudinal motion imparted by the ball nut assembly along the ball nut axis, and
wherein the MC drive motor rotates a drive shaft having a drive shaft axis which extends substantially parallel to the ball nut axis, and
wherein rotational motion of the drive shaft is transferred to rotational motion of a spindle of the ball nut assembly via an MC gear train.
